(19) United States
(12) Patent Application Publication
(10) Pub. No.: US 2018/0163780 A1
(43) Pub. Date: Jun. 14, 2018

(54) SUPERELASTIC BALLS FOR BALL BEARINGS AND METHOD OF MANUFACTURE

(71) Applicant: Heraeus Deutschland GmbH & Co. KG, Hanau (DE)

(72) Inventor: Christian de Graffenried, La Tour-De-Peilz (CH)

(73) Assignee: Heraeus Deutschland GmbH & Co. KG, Hanau (DE)

(21) Appl. No.: 15/578,519

(22) PCT Filed: Jun. 1, 2016
(86) PCT No.: PCT/EP2016/062346

§ 371 Date: Nov. 30, 2017

(30) Foreign Application Priority Data
Jun. 2, 2015 (EP) 15170295.8
Dec. 21, 2015 (EP) 15201552.5

(51) Int. Cl. F16C 33/32; F16C 19/06; F16C 27/04; F16C 43/06

(52) U.S. Cl. CPC F16C 33/32; F16C 19/06; F16C 2300/12; F16C 43/065; F16C 2204/52; F16C 27/04

(57) ABSTRACT

One aspect relates to a rolling element for a ball bearing wherein the rolling element has: (i) a Young modulus E in the range up to and including 100 GPa; and (ii) a yield strength Rp_{0.2} in the range up to and including 1800 MPa, or wherein the rolling element has at least an alloy of nickel (Ni) and titanium (Ti), wherein the weight ratio of Ni:Ti in the alloy is in the range of from 57:43 to 50:50. One aspect is a rolling bearing with: a. at least an outer ring; b. at least an inner ring, wherein a raceway is defined by the arrangement of the outer ring and the inner ring; and c. at least three rolling elements wherein the rolling elements are arranged in the raceway, wherein at least one rolling element comprises at least an alloy as mentioned above.

### SUMMARY

One embodiment relates to a rolling element for a ball bearing wherein the rolling element has these properties: (i) a Young modulus E in the range up to and including 100 GPa; and (ii) a yield strength Rp_{0.2} in the range up to and including 1800 MPa, further to a rolling bearing at least comprising: a. at least an outer ring; b. at least an inner ring, wherein a raceway is defined by the arrangement of the at least one outer ring and at least one inner ring; and c. at least three rolling elements wherein at least one rolling element is as mentioned before, wherein the rolling elements are arranged in the raceway.

One embodiment also relates to a rolling element for a ball bearing wherein the rolling element comprises at least an alloy of nickel (Ni) and titanium (Ti), wherein the weight ratio of Ni:Ti in the alloy is in the range of from 57:43 to 50:50, and to a rolling bearing at least comprising: a. at least an outer ring; b. at least an inner ring, wherein a raceway is defined by the arrangement of the at least one outer ring and at least one inner ring; and c. at least 3 rolling elements wherein the rolling elements are arranged in the raceway, wherein at least one rolling element comprises at least one alloy of nickel and titanium, wherein the weight ratio of Ni:Ti in the alloy is in the range of from 57:43 to 50:50.

A preferred embodiment, relates to a rolling element for a ball bearing which comprises the above mentioned alloy of Nickel (Ni) and titanium (Ti), and further has the above cited Young modulus E and yield strength Rp_{0.2}. Further embodiments include a rolling bearing as mentioned before and comprising at least one rolling element of this kind.

One embodiment also relates to a method of manufacturing rolling elements which are balls comprising the steps of:
i-1) providing a precursor (60, 62), wherein the precursor (60, 62) comprises at least an alloy of Nickel and Titanium, wherein the weight ratio of Ni:Ti in the alloy is in the range of from 57:43 to 50:50, wherein the amount of alloy in the precursor (60, 62) is from 85 wt. % to 100 wt. %, based on the total weight of precursor (60,62); or
i-2) providing a precursor, wherein the precursor has a.) a Young modulus E in the range up to and including 100 GPa; and b.) a yield strength Rp_{0.2} in the range up to and including 1800 MPa;
i-3) providing a precursor which the features mentioned in alternative i-1) and alternative i-2) above;
ii) cutting off ball blanks from the precursor, wherein the ball blanks are cubical or cylindrical in shape; and
iii) grinding the ball blanks in a ball grinder to a desired spherical shape and size, whereby balls for ball bearings are obtained.

One embodiment further relates to a method of manufacturing the aforementioned rolling bearing; and to an article comprising at least one of aforementioned rolling bearings, which can be operated in absence of lubricants, and further to a use of Nitinol 50 for balls for ball bearings (1).

### BACKGROUND

Balls and ball bearings are known. However standard ball bearings do not meet the particular needs of many miniature applications such as micro-mechanics, medical handheld devices, pacemakers and watches, such as wrist watches, wall clocks and clocks in general. For these devices, some materials for balls and ball bearings have been proposed but all of them have their disadvantages.

Lubricated ball bearings are available at low cost. They are usually made of stainless steel or hard metal balls. To avoid friction and noise, the bearing is lubricated with oil. Such ball bearings are not shock proof and exhibit bad ageing characteristics because of oil slurry formed over time.

Lubricant free ball bearings with balls of ZrO₂ are known from EP 1 520 111 B2. These ball bearings exhibit excellent ageing characteristics, are very efficient and no cold welding is observed. However, the hardness of ZrO₂ is much higher than the hardness of the raceway which is stainless steel. As a result, these bearings are not shock proof and produce much noise.

Another type of ball bearings is made from stainless steel with balls of Nitinol 60. Nitinol 60 is an alloy with a weight ratio of nickel to titanium equal to 60 wt.-% nickel and 40 wt.-% titanium, based on the weight of the alloy. However, it is a challenge to machine the Nitinol 60 material to form the desired objects such as balls for ball bearings. Furthermore, the shock-proofness of ball bearings with Nitinol 60 balls and stainless steel bearing is also limited. This means that balls of Nitinol 60 can still cause indents to steel raceways during mechanical shock.

In general, there are a number of requirements for the ball bearings in miniature applications and for the materials and material combinations used:
no cold welding of the balls with the raceway and/or the bearing,
corrosion resistance,
non-magnetic materials for both balls and bearing,
shock resistance,
resilience,
no breakage upon shock,
no indentation on raceways or deformation of balls during shock,
low in noise during operation,
low in wear over time,
thermal shock resistance,
machinable materials,
good polishability.

Despite all efforts of the past to provide ball bearings which are suited for miniature applications, there is still an ongoing need for further development of ball bearings and processes of manufacture in order to satisfy all of the above requirements.

Accordingly, it is an object of one embodiment to provide improved balls, ball bearings and manufacturing processes.

Another object of one embodiment is to provide rolling elements for ball bearings, in particular miniature ball bearings, which are improved with regard to at least one, preferably two or more of the above mentioned requirements. Another object of one embodiment is to provide such improved miniature ball bearings for clocks and watches.

Another object of one embodiment is to provide a rolling bearing which is long lasting.

Another object of one embodiment is to provide a rolling bearing which has no or little need for maintenance, preferably during the life cycle of a watch, e.g. over 10 to 20 years.

Another object of one embodiment is to provide a rolling bearing which does not flake, break or deform, when exposed to a shock.

Another object of one embodiment is to provide a rolling bearing which is silent during operation.

Another object of one embodiment is to provide an efficient method of manufacturing rolling elements.

Another object of one embodiment is to provide a method of manufacturing rolling elements which is well preferably suited for alloys of Nickel and Titanium, yet more preferred for those with a weight ratio of Ni:Ti in the alloy is in the range of from 57:43 to 50:50.

Another object of one embodiment is to provide a process of rolling bearing a rotating axis of an article, preferably a watch or a clock.

Another object of one embodiment is to provide materials which are better suited for balls of ball bearings than those already known.

Another object of one embodiment is to provide materials for balls of ball bearings with which at least one of the requirements for ball bearings set out above can be fulfilled.

A contribution to the solution of at least one of the above objects is provided by the subject-matter of the category-forming claims. The dependent sub-claims of the category-forming claims represent preferred embodiments of the invention, the subject-matter of which likewise makes a contribution to solving at least one of the objects mentioned above.

### Embodiments

I A rolling element (5) for a ball bearing (5)
   wherein the rolling element (5) comprises at least an alloy of Nickel and Titanium,
   wherein the weight ratio of Ni:Ti in the alloy is in the range of from 57:43 to 50:50,
   wherein the amount of alloy in the rolling element (5) is from 85 wt. % to 100 wt. %, based on the total weight of the rolling element (5).
II The rolling element (5) of embodiment I, wherein the weight ratio of Ni:Ti in the alloy is in the range of from 56:44 to 54:46.
III The rolling element (5) of any one of embodiments I or II, wherein the rolling element (5) is a sphere.
IV A method of manufacturing rolling elements (5) which are balls (2) comprising the steps of:
   i) providing a precursor (60, 62), wherein the precursor (60, 62) comprises at least an alloy of Nickel and Titanium, wherein the weight ratio of Ni:Ti in the alloy is in the range of from 57:43 to 50:50, wherein the amount of alloy in the precursor (60, 62) is from 85 wt. % to 100 wt. %, based on the total weight of the precursor (60, 62);
   ii) cutting off ball blanks (64) from the precursor (60, 62), wherein the ball blanks (64) are cubical or cylindrical in shape;
   iii) grinding the ball blanks (64) in a ball grinder (44) to a desired spherical shape and size, whereby balls (5) for ball bearings (1) are obtained.
V The method of embodiment IV, wherein the alloy is Nitinol 50.
VI A rolling bearing (1) at least comprising
   a. at least an outer ring (2) and
   b. at least an inner ring (3), wherein a raceway (4) is defined by the arrangement of the at least one outer ring (2) and at least one inner ring (3), and
   c. at least 3 rolling elements (5) wherein the rolling elements (5) are arranged in the raceway (4), wherein at least one rolling element (5) comprises at least one alloy of Nickel and Titanium, wherein the weight ratio of Ni:Ti in the alloy is in the range of from 57:43 to 50:50, wherein the amount of alloy in the rolling element (5) is from 85 wt. % to 100 wt. %, based on the total weight of the rolling element (5).
VII The rolling bearing (1) according to embodiment VI, wherein the weight ratio of Ni:Ti in the alloy of the at least one rolling element (5) is in the range of from 56:44 to 46:54, the ratio based on the weight of the rolling elements (5).
VIII The rolling bearing (1) of any one of embodiments VI or VII, wherein each rolling element (5) of the rolling bearing (1) is a ball.
IX The rolling bearing (1) according to any one of embodiments VI or VIII, wherein at least one of the inner ring (3) or the outer ring (2) is made from stainless steel.
X The rolling bearing (1) of any one of embodiments VI to IX, wherein the inner diameter of the inner ring (3) of the rolling bearing (1) is in the range of from 1 mm to 100 mm.
XI The rolling bearing (1) of any one of embodiments VI to X, wherein no lubricant is present in the raceway (4).
XII A method of manufacturing a rolling bearing (1) comprising at least the steps of:
   (I) Providing at least these items:
      a. an outer ring (2),
      b. at least an inner ring (3) and
      c. at least 3 rolling elements (5); wherein at least 1 rolling element (5) is composed of at least one alloy of Nickel and Titanium, wherein the weight ratio of Ni:Ti in the alloy is in the range of from 57:43 to 50:50, wherein the amount of alloy in the rolling element (5) is from 85 wt. % to 100 wt. %, based on the total weight of the rolling element (5); and
   (II) Assembling the elements provided in step i) wherein a rolling bearing (1) is obtained, which has a raceway (4) which is defined by the arrangement of the at least one outer ring (2) and at least one inner ring (3), wherein the rolling elements (5) are arranged in the raceway (4).
XIII The method according to embodiment XII wherein the weight ratio of Ni:Ti in the alloy is in the range of from 56:44 to 46:54, the ratio based on the weight of the elements.
XIV The method according to any one of embodiments XII to XIII, wherein the rolling bearing (1) is a ball bearing.
XV An article comprising at least one rolling bearing (1) according to any one of embodiments VI to XI or a rolling bearing (1) obtainable by a method according to any one of embodiments XII to XIV.
XVI The article according to embodiment XIV, wherein the rolling bearing (1) is operated without any lubricant.
XVII A process of rolling bearing a rotating axis of an article, whereby at least one rolling bearing (1) according to any one of embodiments VI to XI is used, and wherein the rotating axis is operated at in the range of from 1 to 150 oscillations per minute.
XVIII A use of Nitinol 50 for balls for ball bearings (1).

### Further Embodiments

(I) A rolling element for a rolling bearing, wherein the rolling element has these properties:
   (i) a Young modulus E in the range up to and including 100 GPa; and
   (ii) a yield strength Rp_{0.2} in the range up to and including 1800 MPa
(II) The rolling element of embodiment (I), wherein the rolling element is a ball.
(III) The rolling element of any one of embodiments (I) to (II), wherein the rolling element comprises at least one alloy in an amount of from 85 wt.-% to 100 wt. %, based on the total weight of the rolling element.
(IV) The rolling element of any one of embodiments (I) to (III), wherein the at least one alloy is selected from the group consisting of nickel-titanium, zirconium-nickel, gum metal and bulk metallic glass.
(V) The rolling element of embodiment (IV), wherein the weight ratio of Ni:Ti in the alloy of the rolling element is in the range of from 57:43 to 50:50, preferably in the range of from 56:44 to 54:46, the ratio based on the total weight of the rolling elements.
(VI) A method of manufacturing a rolling element which is a ball comprising the steps of:
   i) providing a precursor,
      wherein the precursor has
      a.) a Young modulus E in the range up to and including 100 GPa; and
      b.) a yield strength Rp_{0.2} in the range up to and including 1800 MPa;
   ii) cutting off ball blanks from the precursor, wherein the ball blanks are cubical or cylindrical in shape;
   iii) grinding the ball blanks in a ball grinder to a desired spherical shape and size, whereby balls for ball bearings are obtained.
(VII) The method of embodiment (VI), wherein precursor comprises at least one alloy which is selected from the group consisting of nickel-titanium, zirconium-nickel, gum metal, bulk metallic glass, wherein the precursor preferably comprises the at least one alloy in an amount of from 85 wt.-% to 100 wt. %, based on the total weight of the precursor.
(VIII) The method of embodiment (VI) or (VII), wherein the weight ratio of Ni:Ti in the alloy of at least one rolling element is in the range of from 57:43 to 50:50, preferably in the range of from 56:44 to 54:46, the ratio based on the total weight of the rolling elements.
(IX) A rolling bearing at least comprising
   a. at least an outer ring and
   b. at least an inner ring, wherein a raceway is defined by the arrangement of the at least one outer ring and at least one inner ring, and
   c. at least 3 rolling elements, wherein the rolling elements are arranged in the raceway,
      wherein at least 1 rolling element has these properties:
      (i) a Young modulus E in the range up to and including 100 GPa; and
      (ii) a yield strength Rp0.2 in the range up to and including 1800 MPa, or is obtainable with a method as described in any one of embodiments (VI) to (VIII).
(X) The rolling bearing of embodiment (IX), wherein each rolling element of the rolling bearing is a ball.
(XI) The rolling bearing according to any one of embodiments (IX) or (X), wherein at least one of the inner ring or the outer ring is made from stainless steel.
(XII) The rolling bearing of any one of embodiments (IX) to (XI), wherein the inner diameter of the inner ring of the rolling bearing is in the range of from 1 mm to 100 mm.
(XIII) The rolling bearing of any one of embodiments (IX) to (XII), wherein the weight ratio of Ni:Ti in the alloy of at least on rolling element is in the range of from 57:43 to 50:50, preferably in the range of from 56:44 to 54:46, the ratio based on the total weight of the rolling elements.
(XIV) The rolling bearing of any one of embodiments (IX) to (XIII), wherein the load improvement ratio LIR of the rolling bearing is 1.5 or more (in particular greater than 2.5), the load improvement ratio LIR being determined according to the method described herein.
(XV) The rolling bearing of any one of embodiments (IX) to (XIV), wherein no lubricant is present in the raceway.
(XVI) A method of manufacturing a rolling bearing comprising at least the steps of:
   (I) Providing at least these items:
      a. an outer ring,
      b. at least an inner ring and
      c. at least 3, preferably 4, 5, 6, 7, 8 or 9 rolling elements;
         wherein at least one, preferable two or more, yet most preferred all of the rolling elements have these properties:
            (i) a Young modulus E in the range up to and including 100 GPa; and
            (ii) a yield strength Rp_{0.2} in the range up to and including to 1800 MPa; and
   (II) Assembling the rolling elements provided in step i), wherein a rolling bearing is obtained, which has a raceway which is defined by the arrangement of the at least one outer ring and at least one inner ring, wherein the rolling elements are arranged in the raceway.
(XVII) The method of embodiment (XVI), wherein the weight ratio of Ni:Ti in the alloy is in the range of from 57:43 to 50:50, preferably in the range of from 56:44 to 54:46, the ratio based on the weight of the rolling elements.
(XVIII) An article comprising at least one rolling bearing according to any one of embodiments (IX) to (XV) or a rolling bearing obtainable by a method according to any one of embodiments (XVI) or (XVII).
(XIX) The article according to embodiment (XVIII), wherein the rolling bearing is operated without any lubricant.
(XX) A process of rolling bearing a rotating axis of an article,
   whereby at least one rolling bearing according to any one of embodiments (IX) to (XV) or obtainable by a method according to any one of embodiments (XVI) or (XVII) is used,
   wherein the rotating axis of the rolling bearing is operated at in the range of 1 to 150 revolutions per minute.
(XXI) A use of a rolling element, wherein the rolling element has these properties:
   (i) a Young modulus E in the range up to and including 100 GPa; and
   (ii) a yield strength Rp_{0.2} in the range up to and including 1800 MPa for balls for ball bearings.

### DETAILED DESCRIPTION

A first aspect of one embodiment is a rolling element for a ball bearing wherein the rolling element comprises at least an alloy of nickel (Ni) and titanium (Ti), wherein the weight ratio of Ni:Ti in the alloy is in the range of from 57:43 to 50:50, preferably in the range of from 56:44 to 52:48, yet more preferred in the range of from 56:44 to 54:46, or from 57:43 to 54:46, wherein the amount of alloy in the rolling element is from 85 wt. % to 100 wt. %, preferably from 90 wt. % to 100 wt. %, or from 93 wt. % to 100 wt. %, or from 90 wt. % to 98 wt. %, or from 93 wt. % to 98 wt. %, each wt. % based on the total weight of the rolling element.

A second aspect of one embodiment is a rolling element for a rolling bearing, preferably a ball bearing, wherein the rolling element has these properties:
(i) a Young modulus E in the range up to and including 100 GPa, (favourably in the range of from 2 to 100 GPa, more favourably 25 to 80 GPa, or from 30 to 60 GPa, or around 50 GPa); and
(ii) a yield strength Rp_{0.2} in the range up to and including 1800 MPa (favourably in the range of from 200 to 1800 MPa, more favourably 500 to 1800 MPa, or from 1000 to 1500 MPa).

A third aspect of one embodiment is a rolling element which has all the features mentioned for a rolling element according to the first aspect of one embodiment and all the features mentioned for a rolling element according to the second aspect of one embodiment, both as mentioned above.

The Young modulus E, the elasticity and the yield strength Rp_{0.2} are favourably determined as described in the section captioned “test methods”.

According to a preferred embodiment of one embodiment, these rolling elements are particularly useful for sub-miniature applications, e.g. in the watch making industry.

Numerous shapes are known for rolling elements for ball bearings, for example cylinders and balls. In a preferred embodiment of one embodiment, the rolling element is a ball.

The term “ball” in the present context refers to a round geometrical and circular three-dimensional object where all points on the surface of the ball are in the same distance to the centre of the ball. A synonym of “ball” in one embodiment is a “sphere”

According to another embodiment, the diameter of the ball is in the range of from 0.4 to 5 mm. Further preferred ranges are 0.2 to 1 mm, 0.2 to 2 mm, 0.4 to 0.7 mm and 0.5 to 1.5 mm.

According to another preferred embodiment, the rolling element comprises at least one alloy in an amount of from 85 wt.-% to 100 wt. %, preferably in an amount of from 90 to 98 wt.-%, or from 94 to 99 wt.-%, each based on the total weight of the rolling element.

The term “alloy” in the present context refers to an intermetallic phase of two or more metals. Preferably, an alloy is a solid homogeneous mixture with no distinct boundaries between any two phases within the mixture. Alloys expose characteristics of metals.

According to another preferred embodiment, the at least one alloy of the rolling element is selected from the group consisting of nickel-titanium (NiTi), zirconium-nickel (ZrTi), Gum metal, bulk metallic glass. Gum Metal is a trade name that refers to an alloy of with the composition Ti-36Nb-2Ta-3Zr-0.3O. BMG (Bulk Metallic Glass is a trade name directed to Mg65Cu25Al10.

A preferred embodiment is a rolling element for a ball bearing wherein the rolling element comprises at least an alloy of nickel (Ni) and titanium (Ti), wherein the weight ratio of Ni:Ti in the alloy is in the range of from 57:43 to 50:50, preferably in the range of from 56:44 to 52:48, yet more preferred in the range of from 56:44 to 54:46, or from 57:43 to 54:46, wherein the amount of alloy in the rolling element is from 85 wt. % to 100 wt. %, preferably from 90 wt. % to 100 wt. %, or from 93 wt. % to 100 wt. %, or from 90 wt. % to 98 wt. %, or from 93 wt. % to 98 wt. %, each wt.-% based on the total weight of the rolling element.

According to a further preferred embodiment, the weight ratio of Ni:Ti in the alloy is 55:45. This denotes an alloy comprising 55 parts by weight of nickel and 45 parts by weight of titanium, which corresponds to an atomic ratio of nickel and titanium of 50:50. A tradename of such an alloy is “Nitinol 50”. Nitinol alloys are available for purchase from a number of suppliers, e.g. from Nitinol Devices & Components, Inc. in Fremont, Calif. 94539, USA, or ATI Wah Chang, 1000 Six PPG Place, Pittsburgh, Pa. 15222, USA.

In a further preferred embodiment, the material which constitutes the rolling element is composed of only a single phase of an alloy of nickel and titanium, the alloy composed as described above. In a further preferred embodiment, the material which constitutes the rolling element can be composed of two phases. One of the two phases is an alloy of nickel and titanium, the alloy composed as described above. The other of the two phases can be a. another alloy of nickel and titanium or b. a stainless steel.

In a further preferred embodiment the Nickel titanium alloy can be present in an austenitic and a martensitic state. The temperature at which conversion to martensitic state begins is referred to as T_{Ms}. In one embodiment, the Nickel titanium alloy is used in austenitic state that is above the T_{Ms} of the alloy. In a preferred embodiment, the T_{Ms} of the alloy is ≤15° C. or less, yet more preferred ≤10° C., or ≤5° C., ≤0° C., or in the range of from −5° C.≤T_{MS}≤+5° C. The T_{Ms} can be adjusted by chemical means, e.g. by adding “impurities” to the alloy, or by physical treatment, e.g. cold working and/or thermal treatment. Physical treatment of the alloy or the made of alloy is preferred.

Another aspect of one embodiment is a method of manufacturing a rolling element which is a ball comprising the steps of:
i-1) providing a precursor, wherein the precursor comprises at least an alloy of nickel and titanium, wherein the weight ratio of Ni:Ti in the alloy is in the range of from 57:43 to 50:50, preferably in the range of from 56:44 to 48:52, yet more preferred in the range of from 56:44 to 46:54, or from 57:43 to 54:46, wherein the amount of alloy in the precursor is from 85 wt. % to 100 wt. %, preferably from 90 wt. % to 100 wt. %, or from 93 wt. % to 100 wt. %, or from 90 wt. % to 98 wt. %, or from 93 wt. % to 98 wt. %, each wt. % based on the total weight of the precursor; or
i-2) providing a precursor (60, 62), wherein the precursor (60, 62) has a.) a Young modulus E in the range up to and including 100 GPa (preferably in the range of from 2 to 100 GPa, more preferably 25 to 80 GPa, or from 30 to 60 GPa, or around 50 GPa); and b.) a yield strength Rp_{0.2} in the range up to and including 1800 MPa (preferably in the range of from 200 to 1800 MPa, more preferably 500 to 1800 MPa, or from 1000 to 1500 MPa); or
i-3) providing a precursor (60, 62) which combines the features mentioned in alternative i-1) and i-2) above;
ii) cutting off ball blanks from the precursor, wherein the ball blanks are cubical or cylindrical in shape;
iii) grinding the ball blanks in a ball grinder to a desired spherical shape and size, whereby balls for ball bearings are obtained.

According to a further preferred embodiment of this method, the weight ratio of Ni:Ti in the alloy is 55:45, or Nitinol 50.

The term “precursor” in the present context refers to a coherent article which can be brought into shape of a ball by a mechanical treatment. Numerous precursors are known in the art. Preferred precursors are wires, rods, cuboid articles, billets, ingots and the like, or sheets. Considering sheets, an example for preferred dimensions of such sheet is 5 mm×200 mm×100 mm, which are cut down into smaller pieces before grinding them to balls. Another way of manufacturing precursors begins with a powder of the alloy of Nickel and Titanium mentioned above. In this case, the precursor is formed by a shaping step, e.g. by sintering process.

The term “blank” in the present context refers to a semi finished part which is obtained by applying at least one or more process steps to the precursor. A “ball blank” is a semi finished part which can be further processed to a ball, e.g. for a ball bearing.

Numerous techniques are known in the art to cut precursor materials, e.g. alloys like the preferred ones of nickel and titanium. Preferred techniques are laser cutting, cutting with diamond cutter wires.

Numerous techniques are known in the art for grinding objects, in particular ball blanks of various shapes, for example cubical or cylindrical. Moreover, numerous techniques are known in the art for grinding objects, in particular ball blanks of various shapes, for example cubical or cylindrical, which are made of an alloy of nickel and titanium according to the preferred embodiment mentioned before. A preferred technique is grinding the objects between grinding wheels.

Another aspect of one embodiment is a rolling bearing, particularly suited for sub-miniature applications, e.g. in the watch making industry, wherein the rolling bearing preferably is a ball bearing, at least comprising
a. at least an outer ring and
b. at least an inner ring, wherein a raceway is defined by the arrangement of the at least one outer ring and at least one inner ring, and
c. at least 3, preferably 4, 5, 6, 7, 8 or 9 rolling elements wherein the rolling elements are arranged in the raceway, wherein at least one, preferable two or more, yet most preferred all of the rolling elements
   c.-1) comprises at least one alloy of Nickel and Titanium, wherein the weight ratio of Ni:Ti in the alloy is in the range of from 57:43 to 50:50, wherein the amount of alloy in the rolling element is from 85 wt. % to 100 wt. %, based on the total weight of the rolling element; or
   c.-2) has
      (i) a Young modulus E in the range up to and including 100 GPa (favourably in the range of from 2 to 100 GPa, more favourably 25 to 80 GPa, or from 30 to 60 GPa, or around 50 GPa); and
      (ii) a yield strength Rp0.2 in the range up to and including 1800 MPa (favourably in the range of from 200 to 1800 MPa, more favourably 500 to 1800 MPa, or from 1000 to 1500 MPa); or
   c.-3) is characterized by the combined features of c-1) and c-2); or
   c.-4) is obtainable with a the above-mentioned method of one embodiment of manufacturing a rolling element;
d. optionally, a cage, preferably made from one selected from the group consisting of a copper beryllium alloy, stainless steel 301, Teflon and other plastics.

The term “raceway” in the present context refers to a guide for ball bearings. Preferably, the raceway is circular around an axis of rotation. An example of a raceway is shown in FIG. 1, Numeral 4 (labelled “space” and “raceway”).

According to another embodiment of this aspect, at least one, preferably all of the rolling elements of the rolling bearing are balls.

According to another embodiment of this aspect, at least one of the inner ring or the outer ring is made from stainless steel. Yet more preferred, both the inner ring or the outer ring are made from stainless steel. Numerous types of stainless steel are known in the art. Preferred types of stainless steel are type no. 1.4197, 1.4123, 1.4125, each according to EN10027-2:1992-09.

According to another embodiment of this aspect, the inner diameter of the inner ring of the rolling bearing is in the range of from 1 mm to 100 mm. Further preferred inner diameters of the inner ring are 4 to 10 mm, or 5 to 8 mm, or 5 to 6 mm; or in the upper part of the range less than 100 mm, or less than 80 mm, or less than 60 mm, for example: 40 to 60 mm, or 45 to 55 mm, or 50 to 60 mm.

According to another embodiment, the diameter of the ball is in the range of from 0.4 to 5 mm. Further preferred ranges are 0.2 to 1 mm, 0.2 to 2 mm, 0.4 to 0.7 mm and 0.5 to 1.5 mm.

According to another embodiment of this aspect, no lubricant is present in the raceway.

The term “lubricant” in the present context refers to all matter which can reduce friction between the rolling elements composed of at least one alloy of Nickel and Titanium and the inner and outer ring which define the raceway. Lubricant can be solid, liquid or pasty. Classic lubricant are liquid or pasty, e.g. oil, fat, wax and the like. Solid lubricants can be materials that are softer than the rings and the balls, e.g. plastics, metal and alloys or chemical compositions of organic and/or inorganic components. A standard plastic useful as solid lubricant is Teflon. Further common lubricants are solid lubricants, e.g. MoS₂, which can be applied as a coating. A common example of a lubricating chemical composition is Moebius Synt-A-Lube (Type 9010, 9020 or 9030) which is a synthetic oil based on alky-aryl-oxydubutylene glycols.

A preferred embodiment of the this aspect is a rolling bearing, particularly suited for sub-miniature applications, e.g. in the watch making industry, wherein the rolling bearing preferably is a ball bearing, at least comprising
a. at least an outer ring and
b. at least an inner ring,
   wherein a raceway is defined by the arrangement of the at least one outer ring and at least one inner ring, and
c. at least 3, preferably 4, 5, 6, 7, 8 or 9 rolling elements wherein the rolling elements are arranged in the raceway, wherein at least one, preferable two or more, yet most preferred all of the rolling elements comprise at least one alloy of nickel and titanium, wherein the weight ratio of Ni:Ti in the alloy of at least one of the rolling elements is in the range of from 57:43 to 50:50, preferably in the range of from 56:44 to52:48, yet more preferred in the range of from 56:44 to 46:54, or from 57:43 to 54:46, all ratios based on the weight of the at least one rolling element, wherein the amount of alloy in the rolling element is from 85 wt. % to 100 wt. %, preferably from 90 wt. % to 100 wt. %, or from 93 wt. % to 100 wt. %, or from 90 wt. % to 98 wt. %, or from 93 wt. % to 98 wt. %, each wt.-% based on the total weight of the at least one rolling element;
d. optionally, a cage, preferably made from one selected from the group consisting of a copper beryllium alloy, stainless steel 301, Teflon and other plastics.

According to an embodiment of the this aspect, every second rolling element in the raceway comprises an alloy different from nickel-titanium or rolling elements made from a plastic, which are both softer and/or smaller than the materials of the raceways. Placing such movable articles made of plastic in the raceway will ease the movement of the balls comprising the nickel-titanium alloy.

A further aspect of one embodiment is a method of manufacturing a rolling bearing particularly suited for sub-miniature applications, e.g. in the watch making industry, wherein the rolling bearing preferably is a ball bearing, comprising at least the steps of:
(I) providing at least these items:
   a. an outer ring,
   b. at least an inner ring and
   c. at least 3, preferably 4, 5, 6, 7, 8 or 9 rolling elements;
      wherein at least one, preferable two or more, yet most preferred all of the rolling elements (5)
         c.-1) is composed of at least one alloy of Nickel and Titanium, wherein the weight ratio of Ni:Ti in the alloy is in the range of from 57:43 to 50:50, based on the total weight of the alloy, wherein the amount of alloy in the rolling element (5) is from 85 wt. % to 100 wt. %, based on the total weight of the rolling element (5); or
         c.-2) wherein at least one of the rolling elements (5) has a Young modulus E in the range up to and including 100 GPa and a yield strength Rp0.2 in the range up to and including 1800 MPa; or
         c.-3) wherein at least one of the rolling elements (5) is characterized by the combined features of c-1) and c-2) above;
         c.-4) is obtainable with a method of one embodiment of manufacturing a rolling element; and
(II) Assembling the elements provided in step (I) wherein the rolling bearing is obtained, which has a raceway which is defined by the arrangement of the at least one outer ring and at least one inner ring, wherein the rolling elements are arranged in the raceway.

The rolling elements of the this aspect of one embodiment are preferably the same as in the first, second or third aspect of one embodiment or those manufactured according to the methods of one embodiment of manufacturing a rolling element. The embodiments discussed with respect to the first, second and third aspect of one embodiment are also embodiments with respect to this aspect of one embodiment.

In a preferred embodiment of this aspect, the at least one rolling element is a ball.

The rolling bearing obtained by the method according to this aspect of one embodiment is preferably the one described above as “another” aspect of one embodiment. The embodiments discussed with respect to the “another” aspect of one embodiment are also embodiments with respect to the rolling bearing obtained by the method of this aspect of one embodiment.

This aspect of one embodiment comprises the step (II)—assembling. General assembling techniques are known in the art. In general, step (II) can be performed by human labor force or automatically using one or more robots. The order of assembly results from the design of the rolling bearing and can be well decided by someone skilled in the art.

A preferred embodiment of this aspect is a method of manufacturing a rolling bearing particularly suited for sub-miniature applications, e.g. in the watch making industry, wherein the rolling bearing preferably is a ball bearing, comprising at least the steps of:
(I) providing at least these items:
   a. an outer ring,
   b. at least an inner ring and
   c. at least 3, preferably 4, 5, 6, 7, 8 or 9 rolling elements;
      wherein at least one, preferable two or more, yet most preferred all of the rolling elements comprise at least one alloy of Nickel and Titanium, wherein the weight ratio of Ni:Ti in the alloy is in the range of from 57:43 to 50:50, preferably in the range of from 56:44 to 52:48, yet more preferred in the range of from 56:44 to 54:46, or from 57:43 to 54:46, wherein the amount of alloy in the rolling element is from 85 wt. % to 100 wt. %, preferably from 90 wt. % to 100 wt. %, or from 93 wt. % to 100 wt. %, or from 90 wt. % to 98 wt. %, or from 93 wt. % to 98 wt. %, each wt.-% based on the total weight of the rolling element; and
(II) Assembling the elements provided in step (I)
   wherein the rolling bearing is obtained, which has a raceway which is defined by the arrangement of the at least one outer ring and at least one inner ring, wherein the rolling elements are arranged in the raceway.

A yet another aspect of one embodiment is an article comprising at least one rolling bearing as described above or a rolling bearing obtainable by the method described above. Preferred articles according to this aspect are selected from the group consisting of a clock, a wrist watch, a pacemaker, and a portable energy harvesting device, e.g. in low power electronics.

In an embodiment of this aspect, the at least one, preferably two or more, or all rolling bearings are operated without any lubricant. The definition, embodiments and examples of lubricants with regard to this aspect of one embodiment are the same as above with regard to the lubricants preferred with the rolling bearing according to one embodiment.

A yet further aspect of one embodiment is a process of rolling bearing a rotating axis of an article, whereby at least one of the above mentioned rolling bearings is used, and wherein the rotating axis is operated at in the range of from 1 to 600 oscillations per minute, for example 1 to 300 oscillations per minute, or 1 to 150 oscillations per minute, or 5 to 100 oscillations per minute, yet more preferable 1 to 80 oscillations per minute, or 1 to 60 oscillations per minute. Often, the rotating axis is operated at in the range of from 20 to 90 oscillations per minute, or in the range of from 30 to 75 oscillations per minute.

In an embodiment of this aspect, the at least one, preferably two or more, or all rolling bearings are operated without any lubricant. The definition, embodiments and examples of lubricants with regard to this aspect of one embodiment are the same as above with regard to the lubricants preferred with the rolling bearing according to one embodiment.

Another aspect of one embodiment is the use of an alloy of nickel and titanium, wherein the weight ratio of Ni:Ti in the alloy is in the range of from 57:43 to 50:50, preferably in the range of from 56:44 to 48:52, yet more preferred in the range of from 56:44 to 46:54, or from 57:43 to 54:46, for balls for ball bearings.

Another aspect of one embodiment is the use of a rolling element, wherein the rolling element has these properties:
(i) a Young modulus E in the range up to and including 100 GPa (favourably in the range of from 2 to 100 GPa, more favourably 25 to 80 GPa, or from 30 to 60 GPa, or around 50 GPa); and
(ii) a yield strength Rp_{0.2} in the range of from 200 to 1800 MPa (favourably in the range of from 200 to 1800 MPa, more favourably 500 to 1800 MPa, or from 1000 to 1500 MPa) for balls for ball bearings.

A preferred embodiment of this aspect is the use of an alloy of nickel and titanium, wherein the weight ratio of Ni:Ti in the alloy is in the range of from 57:43 to 50:50, preferably in the range of from 56:44 to 48:52, yet more preferred in the range of from 56:44 to 46:54, or from 57:43 to 54:46, for balls for ball bearings.

According to a preferred embodiment of this aspect, the load improvement ratio LIR of the rolling bearing (1) is 1.5 or more, more preferably greater than 2.5, or even more preferably 4.0 or more, wherein the load improvement ratio LIR is determined according to the method described herein. Often, the load improvement ratio LIR of a rolling bearing does not exceed a value of 25.

Another aspect of one embodiment is the use of Nitinol 50 for balls for ball bearings.

### BRIEF DESCRIPTION OF THE DRAWINGS

FIG. 1 shows schematically a side view of a bearing according to one embodiment.

FIG. 2 schematically shows a partially sectioned perspective view of a bearing according to one embodiment.

FIG. 3 shows how a partially sectioned perspective view of a variant of the bearing according to one embodiment.

FIG. 4 shows schematically a sectional view of a second embodiment of the bearing according to one embodiment.

FIG. 5 shows the experimental setup used for performing the static indentation test.

FIG. 6 is a perspective view of an ingot of material to be made into balls.

FIG. 7 is a perspective view of a plate of material to be made into balls.

FIG. 8 a perspective view of an industrial laser cutting cubes from the plate shown in FIG. 7.

FIG. 9 is a schematic representation of an abrasive tumbling machine in which the cubes cut from the sheet as shown in FIG. 14 are tumbled to produce “rounded cubes” shown in FIG. 10.

FIG. 10 is a perspective view of a “rounded cube” produced in the tumbler of FIG. 9.

FIG. 11 is a schematic block representing a conventional ball grinder.

FIG. 12 is a spherical ball ground in the ball grinder of FIG. 11.

FIGS. 13-16 are plan views showing a laser cutting pattern for cutting cubical ball blanks from the sheet shown in FIGS. 7 and 8.

FIGS. 17-20 are plan views showing a laser cutting pattern for cutting cylindrical ball blanks from the sheet shown in FIGS. 7 and 8.

FIGS. 21-25 show a process for making roller elements, in flow diagram form, starting from a rod which had been purchased.

FIG. 26 shows a standard Chapuis device.

FIGS. 27 and 28 show results from static indentation tests obtained by the test method described herein.

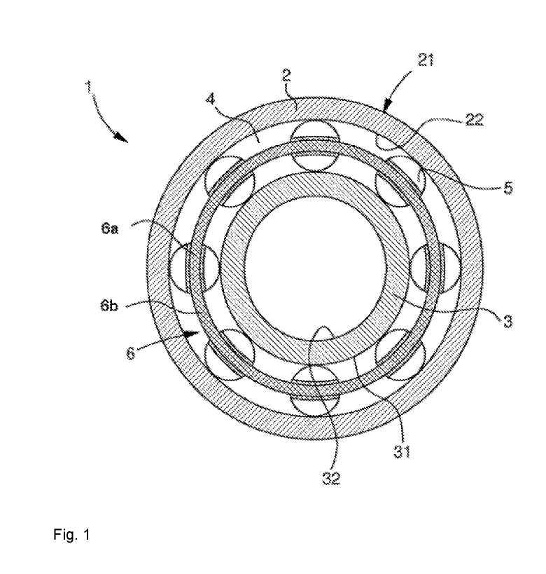

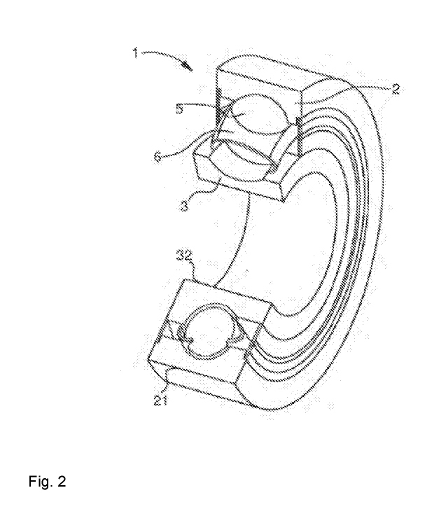

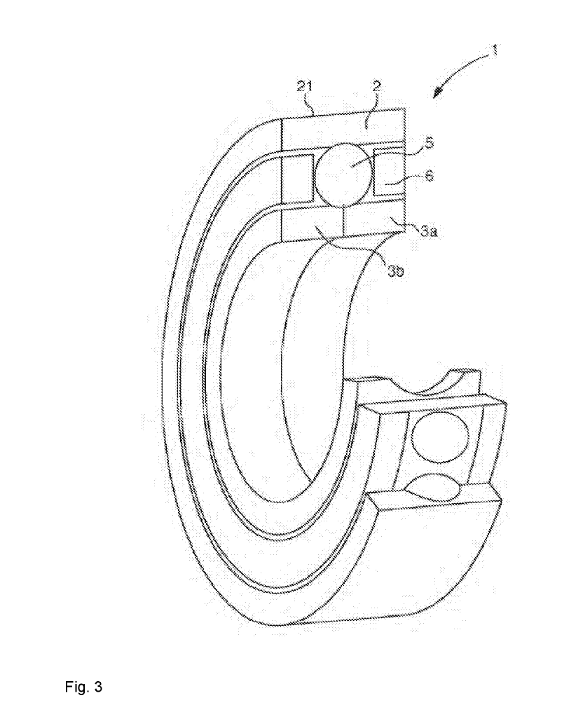

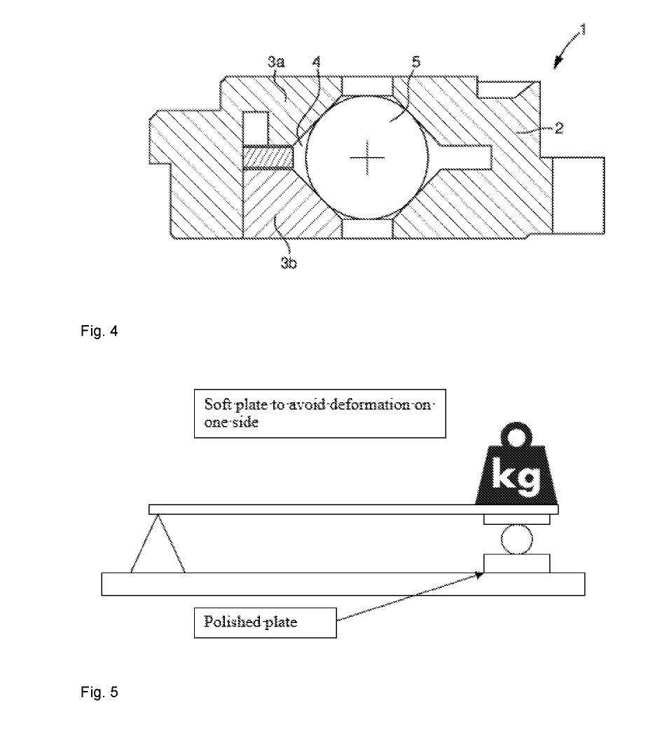

FIGS. 1 and 2 show a bearing 1 which comprises an outer ring 2, an inner ring 3, a number of rolling elements (balls) 5 and a cage 6 to keep the rolling elements spaced from each other. In a variant visible in FIGS. 3 and 4, the bearing comprises more than two points of contact, e.g. three or four points of contact. Then the inner ring 3 is composed of two parts 3a and 3b. The outer ring 2 has an outer face 21 and an inner face 22. The inner face 22 is used as the path for the rolling bodies 5. Preferably, the inner side 22 is curved so as to ease the movement of the rolling elements 5. Indeed, an inner curved face 22 allows for less friction while naturally preventing the rolling bodies 5 out of the way.

The outer ring 2 is fitted with an inner ring 3. The inner ring 3 includes an outer face 31 and an inner face 32. The outer face 31 is also used as a path for the rolling elements 5. In the case of an inner ring 3 consists of two parts 3a and 3b, the parts 3a and 3b are assembled before being inserted into the outer ring 2. The path formed by the outer face 31 of the inner ring 3 and the inner face 22 of the outer ring 2 is designed to allow the movement of rolling bodies 5, wherein said path is adapted to the shape of the rolling body 5.

When the inner ring 3 is inserted into the outer ring 2, a space 4 arises between the inner ring 3 and the outer ring. In this space 4 are placed rolling body 5. The rolling bodies are in the form of balls or cylindrical pieces or tapered cylinder.

The rolling elements 5 are disposed regularly in the said space 4 so that the space between each rolling body 5 is identical. For this, the rolling elements 5 are placed in a cage 6. The cage 6 is in the form of multiple strapping elements 6a interconnected by fastening sections 6b. Indeed, each rolling body 5 is inserted into an element belting 6a. This strapping member 6b is designed so as to maintain the rolling element 5 while allowing it to turn on itself. The attachment sections 6b are used to secure all the rolling elements 5 together. The fastening sections 6b have all the same length in order to leave the roller body 5. Of course, it may be provided that the cage 6 comprises two elements secured together.

The cage 6 with the rolling elements 5 is inserted into the space 4 so that the outer ring 2 and inner ring 3 can rotate independently of each other. The cage 6 must be manufactured precisely to enable both, good maintenance of the rolling elements 5 but also allow them to have a good freedom of movement. The rolling elements 5 are to be inserted by force into the cage 6 is it comprises several assembled parts around the rolling bodies 5.

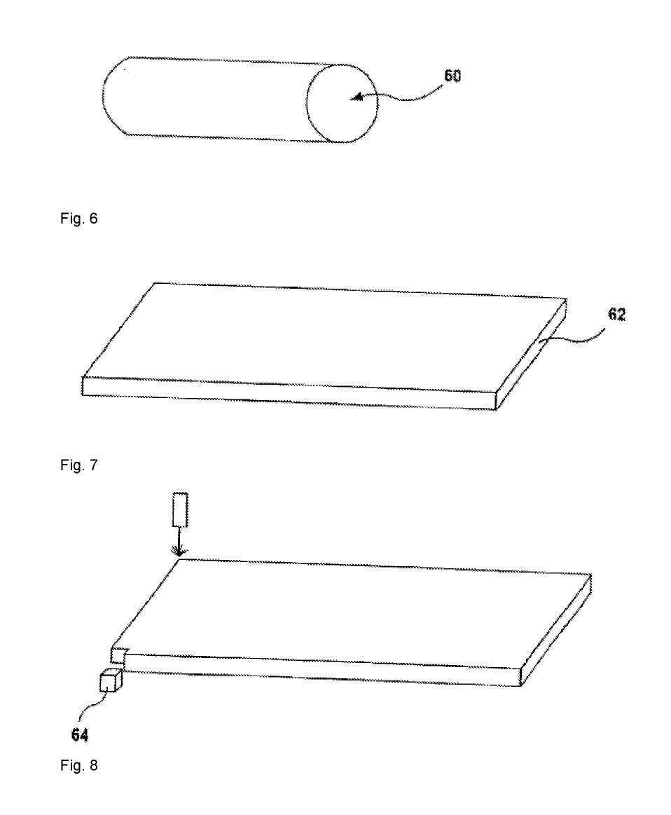

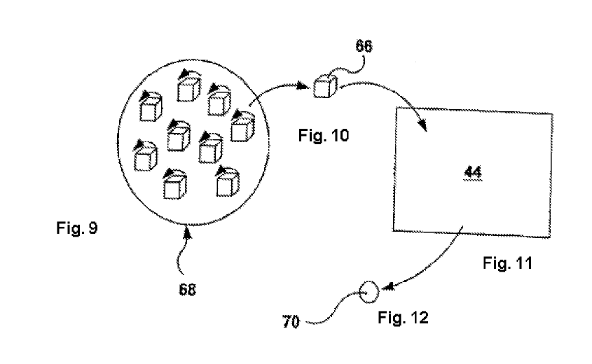

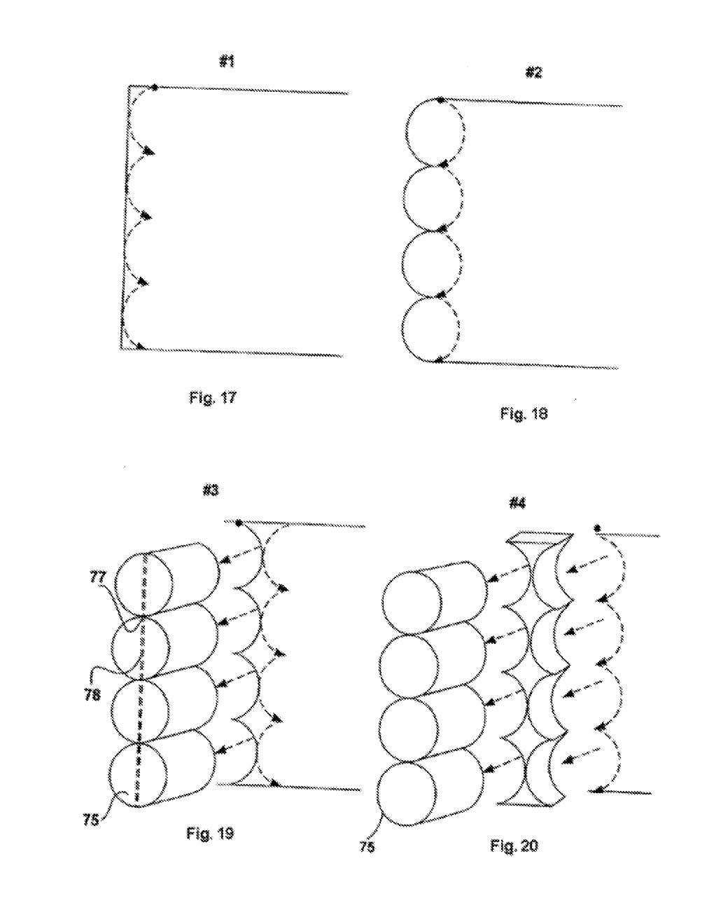

A process for making rolling elements according to one embodiment is shown in FIGS. 12-27, wherein a billet or ingot 60 of the material, shown in FIG. 6, is rolled, cast, or otherwise formed into a plate or sheet 62, as shown in FIG. 7. As shown in FIG. 8, the sheet 62 is cut into cubical ball blanks 64 and the ball blanks 64 are reduced to rounded cubes 66, illustrated in FIG. 10, by abrasive tumbling in a conventional abrasive tumbling apparatus 68 schematically shown in FIG. 9. The rounded cubes 66 are reduced to spherical balls 70, shown in FIG. 12, by grinding in the conventional ball grinder 44, illustrated schematically in FIG. 11.

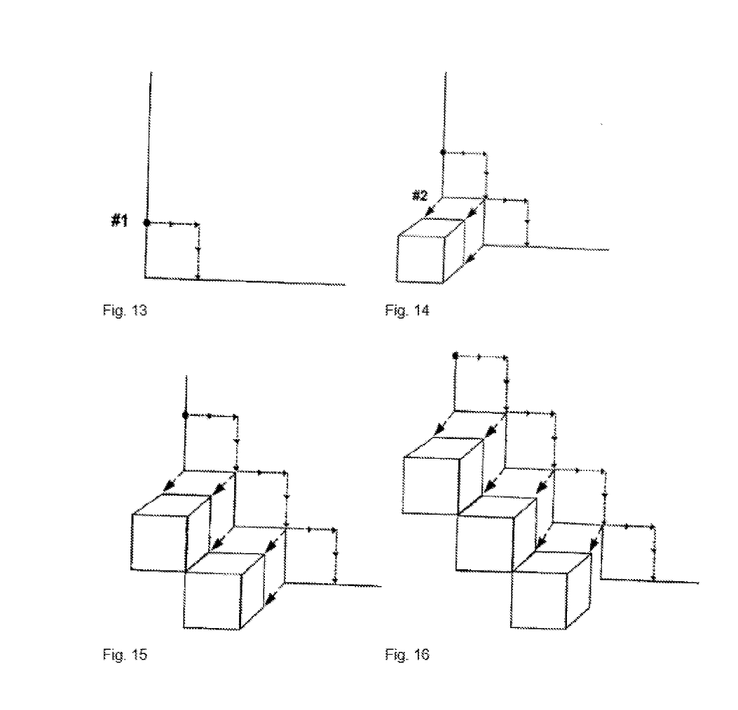

The cubes 64 can be cut from the sheet or plate 62 of the precursor, e.g. Nitinol 50, by laser, following a pattern shown in FIGS. 13-16. As the cubes are cut out of the sheet, they fall through the support grid on which the sheet lies and fall into a pan below. The cubes 64 tend to bounce when they hit the bottom of the pan and the compressed gas from the laser head blows the small cubes 64 out of the pan, so the bottom of the pan can be lined with a material such as felt impregnated with high temperature grease or a mesh material to reduce the tendency of the cubes 64 to bounce and facilitates their capture and easy removal from the pan.

Another ball blank form from which balls can be ground is cylinders. A scalloped laser-cutting pattern, shown in FIGS. 17-20, uses matching semicircular cuts instead of squares to produce cylindrical ball blanks 75 instead of cubes 64. The diameter of the cylinders is equal to the thickness of the plate (not shown) so the three orthogonal dimensions through the center of the cylindrical ball blank 75 are equal, as is the case with the cubical ball blanks 64. The cylindrical ball blanks 75 have smaller corner and edge protrusions and would not require as much time in the tumbler 68 to round off their edges to make them ready for the ball grinder. Indeed, the cylinders 75 may not require any tumbling time at all. However, the laser time to cut cylinders 75 is considerably longer than to cut cubes, and the yield of ball blanks from a sheet or plate of a given size would be less.

A preferred pattern of laser-cutting leaves the cylindrical ball blanks 75 connected at the cusp 77 to produce a string of cylinders 75 connected by a small rib 78 at adjacent edges. The laser travel mechanism is accurate enough to leave a rib that is only a few thousandths of an inch thick allowing the cylinders 75 in the string of cylinders to be easily broken apart after cutting.

FIG. 26 is a schematic representation of a standard Chapuis device. Basically, the standard Chapuis device transforms a rotational movement into an oscillating movement. It consists of at least wheels A and C are shown, further may exist, e.g. wheel B or others (not shown). The wheels are in a motional relationship determined by a connecting rod mounted to and conecting wheel A and wheel B, and further by the teeth of toothed wheels B and C. More specifically, wheel A is driven by a motor (not shown). The rotating motion of wheel A is transformed into an oscillating motion at wheel B by a connecting rod D. The angle at the rotating axis in the center of wheel B and the two points I₁ and I₂ is about 150°, where the rotational direction of wheel B is inverted. The oscillating motion of toothed wheel B is transferred to a further toothed wheel C, eventually using one or more further intermediate wheels (not shown). A sample holder capable of holding up to ten roller bearings, or devices with roller bearings, e.g. a wrist watch, is mounted on wheel C. The speed ratio between wheel B and wheel C is adjusted so that wheel C performs one full revolution around its axis when wheel B is rotated from the first point of inversion I₁ to the second point of inversion I₂. The watch mounted on the sample holder performs 34 oscillations back and forth per minute during the test.

### Roller Bearing Elements

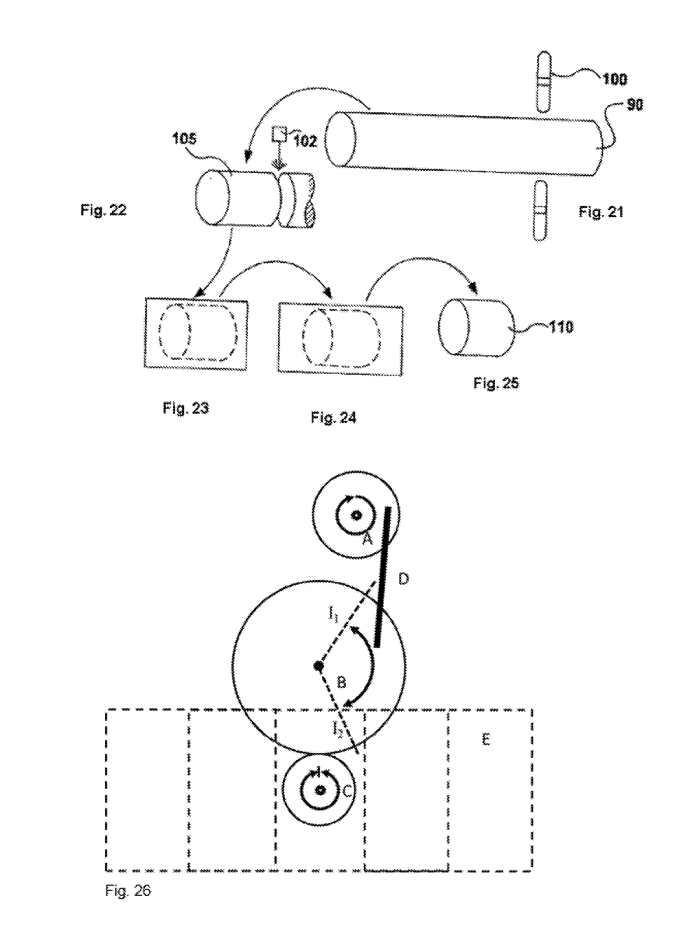

Turning now to FIGS. 21-25, a process for making roller elements (e.g. from Nitinol 50) for roller bearings, shown in flow diagram form, starts rod which had been purchased. The rod 90 is polished using a rod polishing machine 100 to a smooth surface finish on the order of 1 microinch. It is then removed to a cutting operation as shown in FIG. 22, preferably an automated roto-ase cutting machine having a rod support that rotates the polished rod 90 under the laser 102 to cut it cleanly into properly sized roller bearing element blanks 105 without significant waste of material. The cut roller bearing element blanks 105 may be edge trimmed to chamfer and polish the ends of the blanks 105 to produce finished roller elements 110.

Embodiments are further exemplified by examples. These examples serve for exemplary elucidation of one embodiment and are not intended to limit the scope of the embodiments or the claims in any way.

### Test Methods

### 1. Static Indentation Test

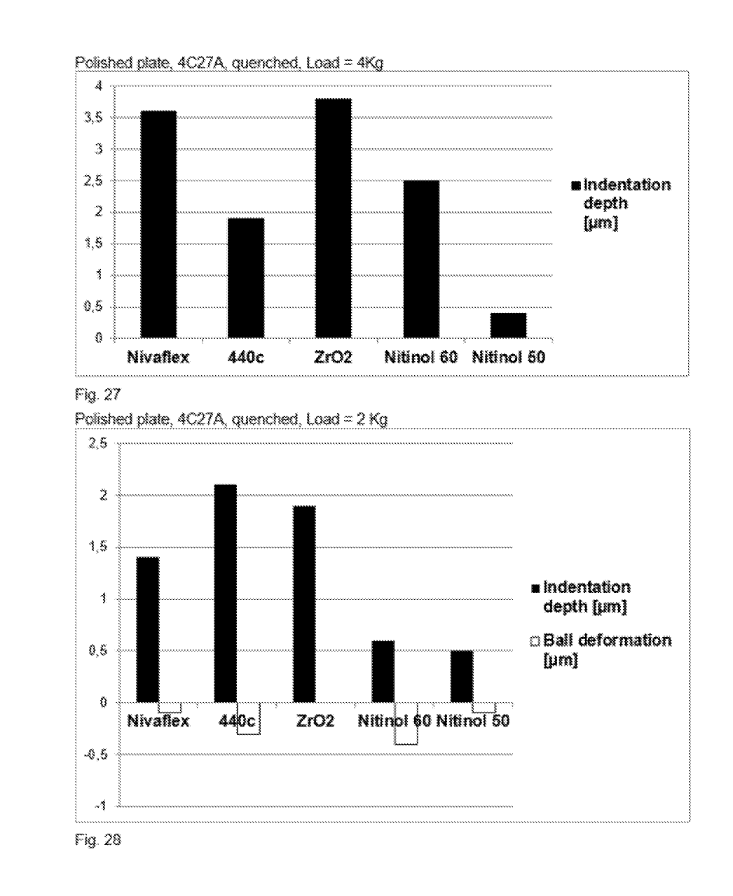

A polished plate of the race material with dimension 10 mm is placed on the testing device. The ball to be tested having a diameter of 0.4 mm is carefully placed on the plate, which has a thickness of 5 mm. The plate is made from the material used for the raceway. Then a calibrated weight of 2 kg (4 kg) is carefully applied to the ball in a smoothly way without any shock during for 5 s. Then, the weight is removed and indentation depth and diameter on the plate are measured by mean of a White Light Interferometer Microscope (Zygo White Light Interferometer). The deformation of the ball is measured with a mechanical micrometre (Meseltron). Reference is made to FIG. 5 which shows a sketch of the testing set-up, result are shown in FIG. 27 for 2 kg load and 28 for 4 kg load. The top plate is an aluminum plate with thickness=2 mm. The sole purpose of the top plate is to stabilize the position of the calibrated weight on the ball.

### 2. Ageing Test

Ageing tests are performed on a standard “Chapuis” device. The test consists in rotating the mass of an automatic watch during 90 days. It corresponds to a real life cycle of 10 years. No tribo-corrosion should occur in the ball bearing and the winding performance should be still acceptable.

The bearing is mounted on an oscillating mass which is then assembled in a real watch movement. The watch is wound up so that the mechanism can start. The watch is placed on the Chapuis device. The Chapuis device rotates the watch back and forth at a rate of 34 rpm.

The working principle of a Chapuis device is further detailed in FIG. 23. Several wheels A, B and C are shown, further may exist (not shown). The wheels are in a rotational relationship determined by a mounted connecting rod and further by the teeth of toothed wheels. More specifically, wheel A is driven by a motor (not shown). The rotating motion of wheel A is transformed into an oscillating motion at wheel B by a connecting rod D. The angle at the rotating axis in the center of wheel B and the two points I₁ and I₂ where the rotational direction of wheel B is inverted is about 150°. The oscillating motion of toothed wheel B is transferred to a further toothed wheel C, eventually using one or more further intermediate wheels (not shown). A sample holder capable of holding up to ten roller bearings, or devices with roller bearings, e.g. a wrist watch, is mounted on wheel C. The speed ratio between wheel B□and wheel C is adjusted so that wheel C performs one full revolution around its axis when wheel B is rotated from the first point of inversion I₁ to the second point of inversion I₂. The watch mounted on the sample holder performs 34 oscillations back and forth per minute during the test.

### 3. Young's Modulus & Tensile Strength of Metallic Materials

Testing of a sample wire is carried out using a Zwick Roell machine Z005. The sample is fixed at its ends between two sets of grips Type 8206 (maximum testing force 2.5 kN) of the machine. The first end of the sample is secured within the first set of grips, and the second end of the sample is secured within the second set of grips. The diameter and length of the sample between the two sets of grips is entered into the software of the Zwick Z005 machine. Then, the upper set of grips is pulled in the Zwick machine at a constant speed rate of 25 mm/min until rupture of the sample whilst recording the force required for the constant pull rate. A test report comprising the values of Rₘ (for a superelastic alloy such as Nitinol, the Yield Strength R_{p0.2} corresponds to the Upper Plateau) is retrieved from the machine. R_{p0.2} (=yield strength at 0.2% elongation) is determined graphically from the chart in the report.

Young's modulus is calculated for the region that shows a linear behavior. This is at the very beginning of the curve for Nitinol samples. For samples exhibiting superelastic properties, e.g. Nitinol samples, secant Young's modulus is calculated by measuring the slope of the line between origin and the end of the plateau (typically at 6 to 8% deformation) according to E=σ/ε.

Testing of the sample is further characterized by the following parameters:

| Parameter | Value | |
|---|---|---|
| Fixation of the wire | grips 2.5 | kN |
| Sample length | 300 | mm |
| Precursor diameter | 0.6 | mm |
| Sensor head | 5 | kN |
| Preload | 10 | N/mm² |

| | |
|---|---|
| Method of measurement of the | crosshead motion |
| elongation | |

### 5. Load Improvement Ratio LIR

The load improvement ratio LIR is calculated using the yield strength Rp_{0.2}, Young Modulus E and the Poisson coefficient V. The value of LIR indicates how much higher an impact (applied force) of a ball of a material could be with reference to a system of ZrO₂ balls and flat race of 4C27A stainless steel without plastically deforming (indenting) the race, each testing setup having the same geometry. Poisson coefficient of metals and alloys is in general between 0.2 and 0.4. The influence on the result of calculation is little. Poisson coefficient was assumed to be constant, i.e. to equal 0.3 in all cases (metals and alloys) for the purpose of the present calculation. The calculation is performed in the following way:
Material of the races (reference=4C27A): E₀, Y₀, V₀
Material of the balls (reference=ZrO2): E₁, Y₁, V₁
Material of the new balls: E₂, Y₂, V₂
   Wherein Eₙ is the Young modulus, Yₙ is the yield strength Rp_{0.2} and Yₙ is Poissons ratio. (with: n=0,1,2 and Vn=0.3). Pn (n=1,2) stands for the load of the ball and the race. The Load Improvement Ratio LIR is defined as:

LIR=P₂/P₁=(Min[Y₂;Y₀]³/Min[Y₁;Y₀]³)*(E₁′²/E₂′²)

with

1/E₁′=(1−V₀²)/E₀+(1−V₁²)/E₁

1/E₂′=(1−V₀²)/E₀+(1−V₂²)/E₂.

### EXAMPLES

### 1. Manufacture of Nitinol 50 Balls

Straight Nitinol wires of 0.5 m in length were cut to pieces of a length of about 50 mm. Then a bundle of several hundreds of wire was placed in a support. The bundle was then cut into slices with a thickness equal to the wire diameter. Thereby, small cylinders were obtained. The cylinders were placed in a vibratory tumbler in order to smooth all the edges through the treatment in the tumbler. The rounded cylinders were then placed in a lapping machine in order to get accurate, perfectly round and shiny balls. The whole smoothing process takes about 4-10 weeks.

### 2. Manufacture and Tests of Roller Bearings

Ball bearings were assembled which have a 4 contact points raceway made from stainless steel, quenched of hardness 700HV1, as shown in FIG. 4, suited to bear balls of size of 0.4 mm. Each time seven balls of 0.4 mm were integrated into the bearing. The raceway had a diameter of 4.7 mm. The following examples were produced:

Experimental data—Raceways made from stainless steel, quenched, hardness 700HV1.

| | Static | | Static | Ageing, non |
|---|---|---|---|---|
| Material of the | indentation | Ball | indentation | lubricated |
| balls in the | on raceway | deformation | on raceway | (+ works; − |
| ball bearing | 2 Kg load | 2 Kg load | 4 Kg load | fail) |
| Nivaflex 45/5 | − | + | −− | − |
| Stainless steel | −− | − | − | − |
| 440C | | | | |
| Ceramic | −− | + | −− | + |
| (ZrO2) | | | | |
| Nitinol 60 | + | − | − | + |
| Nitinol 50 | + | + | + | + |
| (Inventive) | | | | |

Meaning of symbols for static indentation tests and ball deformation test:
+ = no indentation/deformation (very little)
− = little indentation/deformation
−− = much indentation/deformation

Measurements on static indentation was performed using a white Light Interferometer (3D Optical Surface Profiler from ZYGO. The ball deformation was measured with a mechanical micrometer.
Description of materials of balls and raceways:

| | Composition (numbers in | |
|---|---|---|
| | brackets are wt-%, based | |
| Material | on total composition) | Supplier |
| Nivaflex | Mulpi-phase alloy: Co | Vacuumschmelze |
| 45/5 | (45), Ni (21), Cr (18), Fe | GmbH&Co. KG, |
| (“Nivaflex”) | (5), W (4), Mo (4), Ti (1), | 63450 Hanau, |
| | Be (0.2) | Germany |
| Stainless | Alloy: Fe (79.15), Cr | Carpenter Technology |
| steel 440C | (17), C (1.1), Mn (1), Si | Corp., Reading, PA |
| (“440C”) | (1), Mb (0.75) | 19612-4662, US |
| Ceramic | Zr (85), O (15) | Kyocera Fineceramics |
| (“ZrO2”) | | GmbH, 73730 |
| | | Esslingen, Germany |
| Nitinol 60 | Alloy: Ni (60), Ti (40) | Abbott Ball Company |
| | | Inc., West Hartford, |
| | | CT 06133-0100, US |
| Nitinol 50* | Alloy: Ni (55), Ti (45) | Abbott Ball Company |
| | | Inc., West Hartford, |
| | | CT 06133-0100, US |
| Stainless | Stainless steel with: C | Sandvik AB, 81181 |
| steel | (0.22), Si (0.6), Mn (1.6), | Sandviken, Sweden |
| 4C27A | P (≤0.03), S (0.18), Cr | |
| | (13), Ni (0.8), Mo (1.2) | |
| Stainless | X40CrMoVN16-2 | Aubert Duval (Groupe |
| steel | | Eramet) |
| 1.4123 | | |
| Beta-Ti c | Ti—3Al—8V—6Cr—4Mo—4Zr | Dynamet (Carpenter) |
| Gum metal | Ti—36Nb—2Ta—3Zr—0.3O | Toyota, Toyotsu, |
| | | Nissey |
| BMG | Mg65Cu25Al10 | Furukawa Techno |
| | | Material Co., |
| | | Kanagawa, Japan |
| CuBe | CuBe2 | Le Bronze Industriel |
| Phynox | Co Cr Ni Mo Mn C Si Fe | Aperam Alloys, 58160 |
| | (39-41 19-21 15-18 | Imphy, France |
| | 6.5-7.5 1.5-2.5 < 0.15 < | |
| | 1.2 bal.) | |

*“50” in “Nitinol 50” refers to atomic ratio, wherein “60” in Nitinol 60” refers to weight ratio. This difference in labelling both Nitinol materials is common in the market and known to the expert.

### 3. Young's Modulus, Yield Strengths Measurements and Load Improvement Calculation

Most of the Young's Modulus and Yield Strengths listed below have been found in tables or on Internet and confirmed by using the above described test methods. As an estimation, the Poisson coefficient has been set to 0.3 for all the materials

| | | | E | Rp_{0.2} | | |
|---|---|---|---|---|---|---|
| | | | or Secant E | or Upper | | |
| | | | for | Plateau for | | |
| | | | superelastic | superelastic | | |
| | | | alloys | alloys | Poisson | |
| example | body | material | [Gpa] | [Mpa] | V | LIR |
| 0 | race | 4C27A | 215 | 1900 | 0.3 | 1 |
| | ball | ZrO2 | 200 | 2500 | 0.3 | |
| 1 | race | 4C27A | 215 | 1900 | 0.3 | 0.9 |
| | ball | 4C27A | 215 | 1900 | 0.3 | |
| 2 | race | ZrO2 | 200 | 2500 | 0.3 | 2.4 |
| | ball | ZrO2 | 200 | 2500 | 0.3 | |
| 3 | race | 1,4123 | 195 | 1825 | 0.3 | 1.0 |
| | ball | ZrO2 | 200 | 2500 | 0.3 | |
| 4 | race | 4C27A | 215 | 1900 | 0.3 | 0.5 |
| | ball | Beta-Ti | 80 | 1000 | 0.3 | |
| 5 | race | 4C27A | 215 | 1900 | 0.3 | 1.5 |
| | ball | Gummetal | 45 | 1100 | 0.3 | |
| 6 | race | 4C27A | 215 | 1900 | 0.3 | 2.3 |
| | ball | BMG | 80 | 1700 | 0.3 | |
| 7 | race | 4C27A | 215 | 1900 | 0.3 | 0.9 |
| | ball | Nivaflex | 220 | 2475 | 0.3 | |
| 8 | race | 4C27A | 215 | 1900 | 0.3 | 0.8 |
| | ball | CuBe | 131 | 1500 | 0.3 | |
| 9 | race | 4C27A | 215 | 1900 | 0.3 | 1.0 |
| | ball | Phynox | 208 | 2400 | 0.3 | |
| 10 | race | 4C27A | 215 | 1900 | 0.3 | 2.5 |
| | ball | NiTi 60 | 95 | 2500 | 0.3 | |
| 11 | race | 4C27A | 215 | 1900 | 0.3 | 5.7 |
| | ball | NiTi 50 | 7 | 550 | 0.3 | |
| | | | secant | | | |
| 12 | race | 1,4123 | 195 | 1825 | 0.3 | 1.0 |
| | ball | ZrO2 | 200 | 2500 | 0.3 | |
| 13 | race | 1,4123 | 195 | 1825 | 0.3 | 1.0 |
| | ball | 1,4123 | 195 | 1825 | 0.3 | |
| 14 | race | 1,4123 | 195 | 1825 | 0.3 | 1.6 |
| | ball | Gummetal | 45 | 1100 | 0.3 | |
| 15 | race | 1,4123 | 195 | 1825 | 0.3 | 2.4 |
| | ball | BMG | 80 | 1700 | 0.3 | |
| 16 | race | 1,4123 | 195 | 1825 | 0.3 | 5.7 |
| | ball | NiTi 50 | 7 | 550 | 0.3 | |
| | | | secant | | | |
| 17 | race | NiTi 60 | 95 | 2500 | 0.3 | 10.8 |
| | ball | NiTi 60 | 95 | 2500 | 0.3 | |
| 18 | race | ZrO2 | 200 | 2500 | 0.3 | 5.9 |
| | ball | NiTi 60 | 95 | 2500 | 0.3 | |
| 19 | race | NiTi 50 | 7 | 550 | 0.3 | 21.3 |
| | | | secant | | | |
| | ball | NiTi 50 | 7 | 550 | 0.3 | |
| | | | secant | | | |
| 20 | race | Gummetal | 45 | 1100 | 0.3 | 4.1 |
| | ball | Gummetal | 45 | 1100 | 0.3 | |
| 21 | race | BMG | 80 | 1700 | 0.3 | 4.8 |
| | ball | BMG | 80 | 1700 | 0.3 | |

The rolling elements of example no. 4, 5, 6, 11, 14, 15, 16, 19, 20 and 21 have
(i) a Young modulus E in the range up to and including 100 GPa; and
(ii) a yield strength Rp_{0.2} in the range up to and including 1800 MPa.
For Nitinol, the Rp0.2 is to the Upper Plateau that is found in the Tensile Test.
The secant Young's Modulus is determined by measuring the slope of the line between the origin and the end of the plateau
Ball bearings according to example no. 5, 6, 10, 11, 17, 18, 19, 20 and 21 have a LIR of 1.5 or more, examples no. 11, 16, 17, 18, 19, 20 and 21 have a LIR of 3.0 or more.

1-26. (canceled)

27. A rolling element for a ball bearing wherein the rolling element comprises at least an alloy of Nickel and Titanium, wherein the weight ratio of Ni:Ti in the alloy is in the range of from 57:43 to 50:50, wherein the amount of alloy in the rolling element is from 85 wt. % to 100 wt. %, based on the total weight of the rolling element.

28. The rolling element of claim 27, wherein the weight ratio of Ni:Ti in the alloy is in the range of from 56:44 to 54:46.

29. The rolling element of claim 27, wherein the rolling element comprises Nitinol 50 and is used for balls for ball bearings.

30. A rolling element for a rolling bearing, wherein the rolling element comprises:
(i) a Young modulus E in the range up to and including 100 GPa; and
(ii) yield strength Rp_{0.2} in the range up to and including 1800 MPa.

31. The rolling element of claim 30, wherein the rolling element is a ball.

32. The rolling element of claim 30, wherein the rolling element comprises at least one alloy in an amount of from 85 wt.-% to 100 wt. %, based on the total weight of the rolling element.

33. The rolling element of claim 30, wherein the at least one alloy is selected from the group consisting of nickel-titanium, zirconium-nickel, gum metal and bulk metallic glass.

34. The rolling element of claim 33, wherein the weight ratio of Ni:Ti in the alloy of the rolling element is in the range of from 56:44 to 54:46, the ratio based on the total weight of the rolling elements.

35. A method of manufacturing rolling elements which are balls comprising:
i) providing a precursor, wherein the precursor comprises at least an alloy of Nickel and Titanium, wherein the weight ratio of Ni:Ti in the alloy is in the range of from 57:43 to 50:50, wherein the amount of alloy in the precursor is from 85 wt. % to 100 wt. %, based on the total weight of precursor;
ii) cutting off ball blanks from the precursor, wherein the ball blanks are cubical or cylindrical in shape; and
iii) grinding the ball blanks in a ball grinder to a desired spherical shape and size, whereby balls for ball bearings are obtained.

36. The method of claim 35, wherein the alloy is Nitinol 50.

37. A method of manufacturing a rolling element which is a ball comprising:
i) providing a precursor,
wherein the precursor has
a.) a Young modulus E in the range up to and including100 GPa; and
b.) a yield strength Rp_{0.2} in the range up to and including 1800 MPa;
ii) cutting off ball blanks from the precursor, wherein the ball blanks are cubical or cylindrical in shape;
iii) grinding the ball blanks in a ball grinder to a desired spherical shape and size, whereby balls for ball bearings are obtained.

38. The method of claim 37, wherein precursor comprises at least one alloy which is selected from the group consisting of nickel-titanium, zirconium-nickel, gum metal and bulk metallic glass, wherein the precursor preferably comprises the at least one alloy in an amount of from 85 wt.-% to 100 wt. %, based on the total weight of the precursor.

39. The method of claim 37, wherein the weight ratio of Ni:Ti in the alloy of at least one rolling element is in the range of from 56:44 to 54:46, the ratio based on the total weight of the rolling elements.

40. A rolling bearing at least comprising
a. at least an outer ring and
b. at least an inner ring, wherein a raceway is defined by the arrangement of the at least one outer ring and at least one inner ring, and
c. at least 3 rolling elements, wherein the rolling elements are arranged in the raceway, wherein at least one rolling element
c.-1) comprises at least one alloy of Nickel and Titanium, wherein the weight ratio of Ni:Ti in the alloy is in the range of from 57:43 to 50:50, wherein the amount of alloy in the rolling element is from 85 wt. % to 100 wt. %, based on the total weight of the rolling element; or
c.-2) has
(i) a Young modulus E in the range up to and including 100 GPa; and
(ii) a yield strength Rp0.2 in the range up to and including 1800 MPa; or
c.-3) is characterized by the combined features of alternatives c.-1) and c.-2) above; or
c.-4) is obtainable by
i) providing a precursor, wherein the precursor comprises at least an alloy of Nickel and Titanium, wherein the weight ratio of Ni:Ti in the alloy is in the range of from 57:43 to 50:50, wherein the amount of alloy in the precursor is from 85 wt. % to 100 wt. %, based on the total weight of precursor;
ii) cutting off ball blanks from the precursor, wherein the ball blanks are cubical or cylindrical in shape; and
iii) grinding the ball blanks in a ball grinder to a desired spherical shape and size, whereby balls for ball bearings are obtained.

41. The rolling bearing of claim 40, wherein each rolling element of the rolling bearing is a ball.

42. The rolling bearing of claim 40, wherein at least one of the inner ring or the outer ring is made from stainless steel.

43. The rolling bearing of claim 40, wherein the inner diameter of the inner ring of the rolling bearing is in the range of from 1 mm to 100 mm.

44. The rolling bearing of claim 40, wherein at least one rolling element comprises at least one alloy of Nickel and Titanium, wherein the weight ratio of Ni: Ti in the alloy of the at least one rolling element is in the range of from 57:43 to 50:50, preferably in the range of from 56:44 to 54:46, the ratio based on the total weight of the rolling elements and has a Young modulus E in the range up to and including 100 GPa and a yield strength Rp0.2 in the range up to and including 1800 MPa.

45. The rolling bearing of claim 40, wherein the load improvement ratio LIR of the rolling bearing is 1.5 or more, the load improvement ratio LIR being determined according to the method described herein.

46. The rolling bearing of claim 40, wherein no lubricant is present in the raceway.

47. The rolling bearing of claim 40, wherein the rolling bearing has a rotating axis in an article, wherein the rotating axis of the rolling bearing is operated at in the range of 1 to 150 revolutions per minute.

48. A method of manufacturing a rolling bearing comprising:
(I) Providing at least these items:
a. an outer ring,
b. at least an inner ring and
c. at least 3 rolling elements; wherein at least one of the rolling elements
c.-1) is composed of at least one alloy of Nickel and Titanium, wherein the weight ratio of Ni:Ti in the alloy is in the range of from 57:43 to 50:50, based on the total weight of the alloy, wherein the amount of alloy in the rolling element is from 85 wt. % to 100 wt. %, based on the total weight of the rolling element; or
c.-2) wherein at least one of the rolling elements has a Young modulus E in the range up to and including 100 GPa and a yield strength Rp0.2 in the range up to and including 1800 MPa; or
c.-3) wherein at least one of the rolling elements has the combined features of c-1) and c-2) above;
c.-4) is obtainable by
i) providing a precursor, wherein the precursor comprises at least an alloy of Nickel and Titanium, wherein the weight ratio of Ni:Ti in the alloy is in the range of from 57:43 to 50:50, wherein the amount of alloy in the precursor is from 85 wt. % to 100 wt. %, based on the total weight of precursor;
ii) cutting off ball blanks from the precursor, wherein the ball blanks are cubical or cylindrical in shape; and
iii) grinding the ball blanks in a ball grinder to a desired spherical shape and size, whereby balls for ball bearings are obtained; and
(II) Assembling the rolling elements provided in step i), wherein a rolling bearing is obtained, which has a raceway which is defined by the arrangement of the at least one outer ring and at least one inner ring, wherein the rolling elements are arranged in the raceway.

49. The method of claim 48, wherein the weight ratio of Ni:Ti in the alloy is in the range of from 56:44 to 54:46, the ratio based on the weight of the rolling elements.
